(19) United States
(12) Patent Application Publication
(10) Pub. No.: US 2025/0106811 A1
(43) Pub. Date: Mar. 27, 2025

(54) LOCATION INFORMATION PROVISIONING

(71) Applicant: TELEFONAKTIEBOLAGET LM ERICSSON (PUBL), Stockholm (SE)

(72) Inventors: Jonas Sedin, BRENTFORD (GB); Emre Yavuz, STOCKHOLM (SE); Sebastian Euler, STORVRETA (SE); Ignacio Javier PASCUAL PELAYO, Stockholm (SE)

(21) Appl. No.: 18/725,278

(22) PCT Filed: Jan. 10, 2023
(86) PCT No.: PCT/IB2023/050216

§ 371 Date: Jun. 28, 2024

Related U.S. Application Data
(60) Provisional application No. 63/298,070, filed on Jan. 10, 2022.

(51) Int. Cl. H04W 64/00; H04W 48/10; H04W 76/10; H04W 84/06

(52) U.S. Cl. CPC H04W 64/006; H04W 48/10; H04W 76/10; H04W 84/06

(57) ABSTRACT

A method (1700) performed by a UE for location provisioning. The method includes determining to send location information. The method also includes, as a result of determining to send location information, sending the location information to a network node. Sending the location information to the network node comprises sending the location information using one or more PURs or sending a connection establishment procedure message as part of a connection establishment procedure, wherein the connection establishment procedure message comprises the location information.

### TECHNICAL FIELD

This disclosure relates to a UE providing location information to a network node.

### BACKGROUND

### LTE Random Access

A 4-step approach can be used for a random access procedure, as shown in FIG. 1A. In this approach, a user equipment (UE) detects a synchronization signal (SS) (e.g., PSS, SSS) and then decodes broadcasted system information (e.g., RSMI, OSI) (which may be distributed over multiple physical channels, PBCH and PDSCH) to acquire random access transmission parameters, followed by transmitting a PRACH preamble (a.k.a., “message 1” or “Msg1”) in the uplink.

The eNB detects Msg1 and replies with a Random Access Response (RAR) message (a.k.a., “message 2” or “Msg2”). The UE then performs a PUSCH transmission (a.k.a., “message 3” or “Msg3”) which includes a UE identification. The UE transmits message 3 after receiving a timing advance command in the RAR and after adjusting the timing of the PUSCH transmission, allowing Msg3 to be received at gNB with a timing accuracy within the cyclic prefix (CP). Without this timing advance functionality, a very large CP would be needed in order to be able to demodulate and detect Msg3, unless the system is applied in a cell with very small distance between UE and gNB. The gNB may then send a contention resolution message (CRM) (a.k.a., “message 4” or “Msg4”).

### Early Data Transmission (EDT)

Early data transmission allows the UE to send user plane data earlier than when it is typically done in legacy, i.e., after Msg5 (PDSCH RLC ACK) (see FIG. 1B), during connection establishment procedure. The motivation is to reduce the delay and UE power consumption for data transmission in the UL since the UE can potentially go back to idle/inactive mode immediately after the transmission.

When sending small data such as a few byte long sensor reports or similar, the signaling overhead due to random access and RRC signaling is relatively high. This is still the case even with EPS CIoT optimizations for user plane and control plane (i.e., RRC Suspend/Resume and Data over NAS procedures) introduced in 3GPP Release 13 (Rel-13). For example, FIG. 1B shows an example of RRC Suspend/Resume procedure for MO traffic case for a LTE-M UE. For a UE to transmit user plane data in the UL, it needs to go through sync acquisition, MIB and at least SIB1-BR acquisition, random access up to Msg4 (e.g. RRC Connection Resume) after which the UE can send the actual data. Similarly, in MT calls, DL data can only be sent after the eNB has received the RRCConnectionResumeComplete message. Similar observation is applicable to Rel-13 Control plane EPS CIoT optimization (DoNAS) where user UL data is contained in a NAS-PDU which can only be delivered by the RRCConnectionSetupComplete message in Msg5.

EDT is motivated by potential gains obtained if user data can already be sent during random access procedure, i.e., earlier than in legacy. More specifically, the UE would benefit in: (1) Latency reduction: If either UL or DL could be sent earlier than in legacy, the latency starting from either the triggered MO or MT event up to the delivery of the data packet to higher layers in eNB or UE would be reduced; (2) UE battery life extension: By reducing the steps needed to send UL or receive DL data, the UE can save cycles in MPDCCH/NPDCCH monitoring and signaling reception and transmission.

In RAN #75, a common objective was approved for both LTE-M and NB-IoT WIs in Rel-15 to support EDT, and it was agreed that RAN2 targets the support of EDT in Msg3 and Msg4 for both User plane and Control plane CIoT EPS optimization, i.e., UP and CP solutions, respectively. For ease of presentation, the messages in the RA procedure are commonly referred to as message 1 (Msg1) through message 4 (Msg4), as illustrated in FIG. 2 (adopted from 3GPP Technical Specification (TS) 36.300 V16.7.0).

Among others, there are some aspects of EDT for LTE-M and NB-IoT which are to some extent applicable to both UP and CP solutions, including: indications used by the UE and the network in support of EDT operations; transport block (TB) size for Msg3 signaled in the UL grant in Msg2 as well as the content of the UL grant itself; how to handle Msg3, i.e., building Msg3 PDU for (re)transmission when UL grant is not sufficient to accommodate user data and segmentation support (only for the UP solution); whether EDT has impact on UE state transition between RRC_IDLE and RRC_CONNECTED; and, with the introduction of EDT, whether Msg5 could be omitted to further reduce signaling thereof latency and power consumption.

Also, in Control Plane optimization for CIoT (also shortened as CP-IoT), there is no Access Stratum (AS) security between the UE and the eNB. Instead the security is between the MME and the UE and the data is sent to the MME via the AS. In User plane optimization for CIoT, AS security is available similar to legacy LTE.

### UP Solution

FIG. 3 shows the signaling flow for UP solution. The RRCConnectionResumeRequest on the CCCH is used in Msg3. For Msg4, RRCConnectionRelease on DCCH is used in case the UE is indicated to go back to idle mode. In addition, it is assumed that the RRCConnectionResume on DCCH is used in case the UE is indicated to move to RRC_CONNECTED mode, respectively. UL/DL user data on DTCH logical channel is MAC multiplexed with signaling SDU in Msg3 and Msg4. In case UE is moved to RRC_CONNECTED mode after Msg4, RRCConnectionResumeComplete in Msg5 is assumed as an explicit confirmation for the completion of resume procedure.

FIG. 4 shows content of the MAC PDU for Msg3 in UP solution. In addition to the MAC header, Msg3 includes a CCCH SDU containing the RRCConnectionResumeRequest and a DTCH SDU for ciphered UL data. The size (in bits) of each component in the PDU is also provided. Note that the CCCH SDU has RRC overhead such as message ID in respective message class (i.e., UL-CCCH-Message), transaction identifier and optionality bits, which are not shown in the figures, whereas the DTCH SDU has layer 2 overhead, i.e., RLC and PDCP headers and AS security information. The total size of Msg3 is thus 16 bytes plus UL data.

FIG. 5 shows detailed content of the MAC PDU for Msg4 in case the UE is indicated to go back to idle mode upon reception of Msg4. Note that Msg4 includes also the Contention Resolution MAC control element. In addition, NCC is provided in the RRCConnectionRelease in Msg4 in case the UE is indicated to return Idle mode. Thus, the total size of Msg4 in UP solution is 31 bytes and DL data. In case the UE is indicated to enter RRC_CONNECTED mode, there is no agreement on the content of Msg4. However, because Msg3 has already reactivated radio bearers and security, it would be beneficial if DL data is multiplexed in Msg4.

As seen in FIG. 4 and FIG. 5, the overhead incurred in UP EDT solution mainly comes from the RLC and PDCP headers and AS security information.

### CP Solution

The signaling and content of Msg3/4 for CP solution is considered with following assumptions/agreements: (1) Non-access stratum (NAS) messages in Msg3 and Msg4 are existing CONTROL PLANE SERVICE REQUEST and ESM DATA TRANSPORT for containing UL/DL data, respectively; (2) a new RRC message is defined for carrying UL NAS-PDU in Msg3; (3) a newly defined RRC message carrying DL NAS-PDU and legacy RRCConnectionSetup in Msg4 in case UE goes to RRC_IDLE mode and RRC_CONNECTED mode, respectively; (4) if there is no indication to go back to idle mode in Msg4, UE continues with connection setup and the legacy RRCConnectionSetup Complete in Msg5 is needed as a confirmation for connection complete.

FIG. 6, FIG. 7A, and FIG. 7B show the signaling flow, content of Msg3, and content of Msg4 in CP solution for the case the UE returns to idle mode, respectively. Details regarding the structure and sizes of NAS messages are provided by referring to 3GPP TS 24.301 V17.5.0 Sections 8.2 and 8.3.

Using a similar analysis on the message size as in the UP solution above, the total size of Msg3 PDU in CP solution is 21 bytes plus and UL data, which is 5 bytes more than that of UP solution. Whereas, the total size of Msg4 PDU in CP solution is 19 bytes plus DL data, which is 12 bytes less than that of UP solution.

### Preconfigured Uplink Resources (PURs)

PURs enable data transmission of small periodic data for stationary UEs in RRC Idle mode. Simplified, a PUR transmission is like EDT but reusing an old TA such that Msg1 and Msg2 can be omitted. The UE is configured (dedicated) with one or more PURs in an initial connection during which the UE also obtains the TA to be used. Back in Idle mode, the UE can transmit UL data according to the configured periodicity and grant without state transition. If the UE does not transmit in a configurable number of consecutive PURs, PUR-skip {2,4,8,spare}, the UE's PUR configuration is implicitly released.

### Non-Terrestrial Network (NTN) Location Provisioning

In 3GPP RAN2 #115-e, New Radio (NR) NTN, the following has been agreed on how to deliver location information to the gNB from the UE. The agreements includes:
(1) If SA3 replies with concern on reporting UE location with any granularity during initial access, RAN2 will revisit agreement/solution for reporting UE location during initial access;
(2) UE coarse location information refers to coarse GNSS coordinates (FFS on the details, e.g. X MSB bits out of 24 bits of longitude/latitude or GNSS coordinates with ˜2 km accuracy). FFS if any enhancements to validate the UE's coarse location information is needed. FFS whether this is only used in initial access or also in connected;
(3) If SA3 has no concern reporting coarse location during initial access, the coarse location information is reported in Msg5, i.e., via RRCSetupComplete/RRCResumeComplete message;
(4) For coarse UE location reporting during initial access, the location granularity is not indicated to UE via SIB;
(5) Enhancements to validate the UE's coarse location information is not needed from RAN2 perspective. Whether this is needed by the network is up to other WGs;
(6) After AS security is established, gNB can obtain a GNSS-based location information from the UE using existing signalling method, i.e., by configuring includeCommonLocationInfo in the corresponding reportConfig. It is up to SA3 to decide whether User Consent is required before NW acquires location information from the UE in NTN. RAN2 discuss whether to send LS to SA3;
(7) Aperiodic location reporting (e.g., via DCI) is not supported Working assumption: Event triggered-based UE location reporting are configured by gNB to obtain UE location update of mobile UEs in RRC_CONNECTED;
(8) Send new LS to SA3 for the need of NTN specific user consent for obtaining UE location by gNB”;
(9) If accepted by SA3, if the gNB has user consent to obtain UE location in NTN, reporting of finer location information/full GNSS coordinates in RRC_CONNECTED can be supported after AS security is enabled; and
(10) Periodic location reporting can also be configured by gNB to obtain UE location update of mobile UEs in RRC_CONNECTED. RAN2 discuss whether it is part of existing periodic measurement report configuration or a new configuration for periodic reporting of UE location.

This means that as of current agreements there will be two ways in which location is delivered, which is either through coarse location or through fine detailed location info. The coarse location is only delivered before AS security in the RRC messages RRCSetupComplete or RRCResumeComplete, i.e when the UE is connecting to a gNB. The detailed location is delivered through the RRC Measurement reporting framework, which means that the network has to set up an RRC measurement reporting configuration in order to deliver a fine location info element.

### SUMMARY

Certain challenges currently exist. For example, while the details of NR NTN are being discussed on how to provide location information, in IoT NTN it has yet to be discussed in detail. In NR NTN, the agreement has been made that the location information should be delivered in Msg5, where the location information will be coarse. In IoT NTN for both EDT and PUR there might not be any Msg5. But there might still need to be location information delivered in order for the network (e.g., base station) to be able to determine the correct mapping. For instance for the network to determine which country that the UE is in, which might also affect to which part of the core network that the data should be delivered to, as this might be separate entities in different countries.

Certain aspects of the disclosure and their embodiments provide solutions to these or other challenges. For example, there is disclosed herein, methods on configuring and delivering location info during EDT or PUR transmissions.

In particular, in one aspect, there is provided a method performed by a UE for location provisioning. The method includes the UE determining to send location information. The method also includes, as a result of determining to send location information, the UE sending the location information to a network node. Sending the location information to the network node comprises: sending the location information using one or more PURs or sending a connection establishment procedure message as part of a connection establishment procedure, wherein the connection establishment procedure message comprises the location information.

In another aspect, there is provided a method performed by a network node for location provisioning. The method includes the network node providing location reporting configuration information to a UE. The method also includes receiving location information from the UE. Receiving the location information comprises receiving the location information using one or more PURs or receiving a connection establishment procedure message as part of a connection establishment procedure, wherein the connection establishment procedure message comprises the location information.

Certain embodiments provide one or more of the following technical advantage(s). For example, certain embodiments enable the network during EDT or PUR transmissions to know the UE location in order to, for example, select a core network in the correct country.

### BRIEF DESCRIPTION OF THE DRAWINGS

FIG. 1A is a signaling diagram.

FIG. 1B is a signaling diagram.

FIG. 2 is a signaling diagram.

FIG. 3 is a signaling diagram.

FIG. 4 illustrates the contents of a MAC PDU.

FIG. 5 illustrates the contents of a MAC PDU for Msg4.

FIG. 6 is a signaling diagram according to some embodiments.

FIG. 7A illustrates the contents of a Msg3 according to some embodiments.

FIG. 7B illustrates the contents of a Msg4 according to some embodiments.

FIG. 8 is a signaling diagram according to some embodiments.

FIG. 9 is a signaling diagram according to some embodiments.

FIG. 10 is a signaling diagram according to some embodiments.

FIG. 11 shows an example of a communication system in accordance with some embodiments.

FIG. 12 shows a UE in accordance with some embodiments.

FIG. 13 shows a network node in accordance with some embodiments.

FIG. 14 shows a host in accordance with some embodiments.

FIG. 15 is a block diagram illustrating a virtualization environment in which functions implemented by some embodiments may be virtualized.

FIG. 16 shows a communication diagram of a host communicating via a network node with a UE over a partially wireless connection in accordance with some embodiments.

FIG. 17 is a flowchart illustrating a process according to some embodiments.

FIG. 18 is a flowchart illustrating a process according to some embodiments.

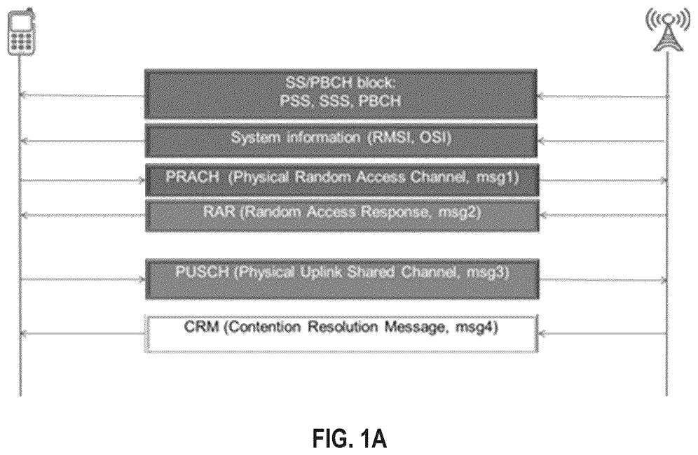

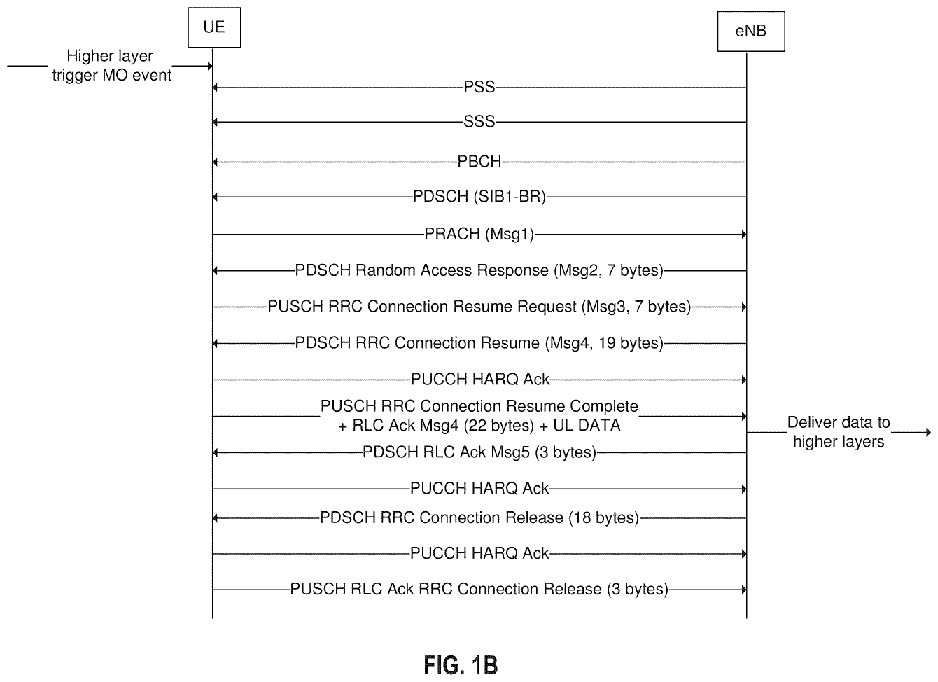

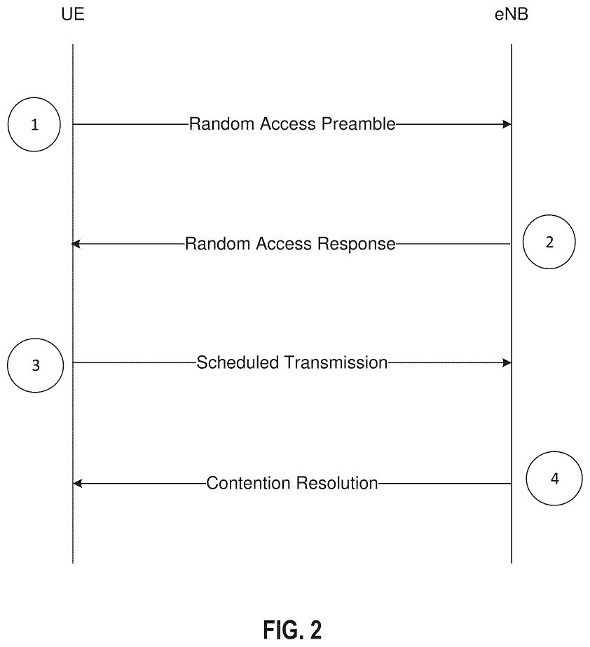

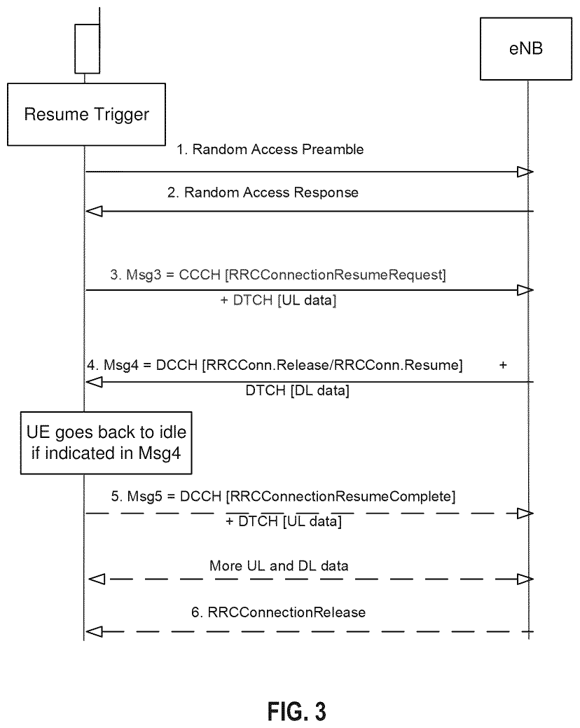

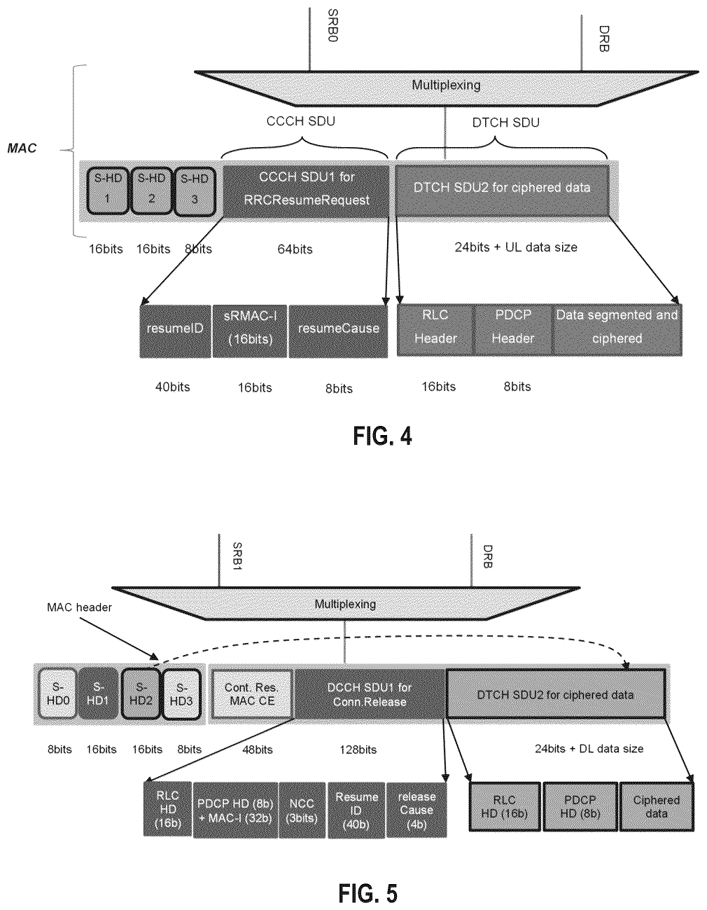

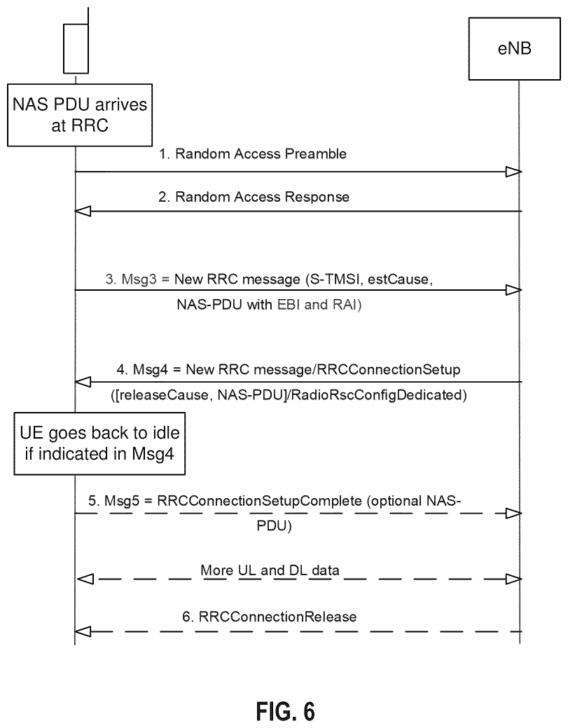

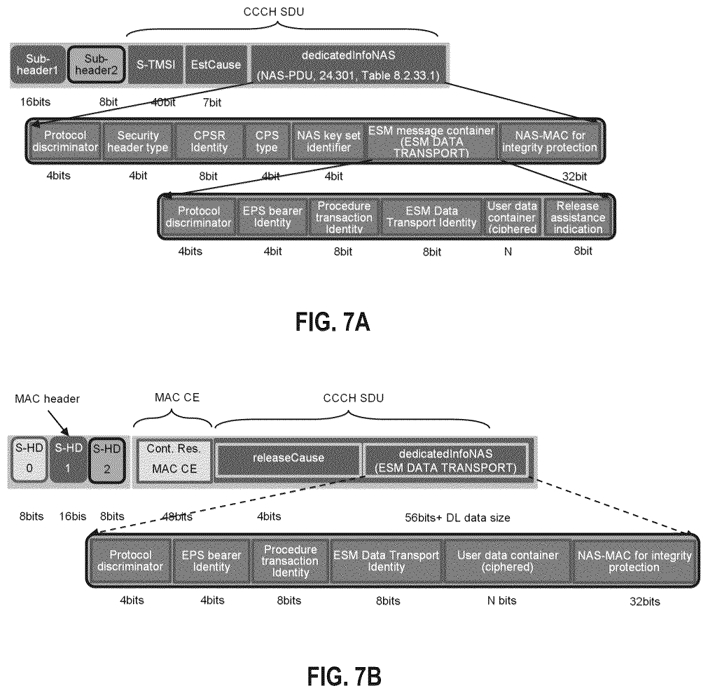

### DETAILED DESCRIPTION

Some of the embodiments contemplated herein will now be described more fully with reference to the accompanying drawings. Embodiments are provided by way of example to convey the scope of the subject matter to those skilled in the art. This section deals with providing location information during EDT and PUR, and while it mainly targets Long Term Evolution (LTE) technology, this can also encompass other features in NR, such as small data transmission (SDT), which is similar as data is transmitted in earlier stages than after random access has been completed.

Reference [2] describes the network determining whether to send coarse or fine location, but it only considers the general configuration of whether to send coarse or fine location.

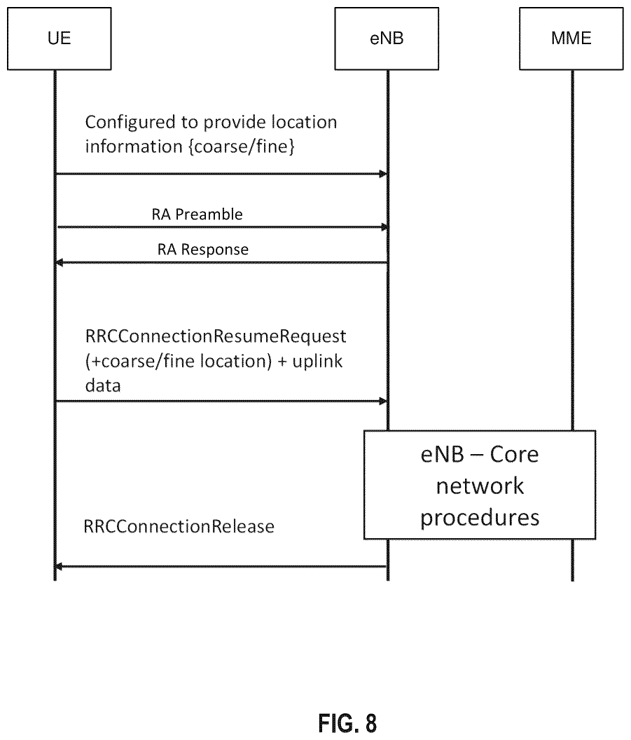

In some embodiments, the LTE base station (a.k.a., “eNB”) configures the UE to send coarse location information, fine location information, or no location information using an EDT or a PUR transmission. This has the benefit that the network can control whether location information should be transmitted or not, which may increase the coverage or the amount of data that the UE will be able to send in the EDT or PUR procedure. This flexibility might be needed because there are multiple types of satellite configurations where different amount of accuracy is required and in some cases no location information could be needed. This example can be seen in FIG. 8.

The configuration can be a part of an EDT configuration or a PUR configuration and can be provided via dedicated or broadcast signaling. The UE action when receiving this configuration information is thus to include the location info whenever the UE sends the EDT or PUR messages. For EDT, the information would be sent in Msg3 where the RRC message would either be RRCEarlyDataRequest or RRCConnectionResumeRequest.

The UE could also potentially be configured that it should provide location information in EDT or PUR message, but whether fine or coarse location is to be transmitted would be up to the UE.

Whether the UE provides the location information could for instance be up to whether the user consent is active or not, or if the UE has not performed an accurate enough estimation. The configuration can also be done in such a manner where if the configuration is specific to whether the UE is using CP-EDT or UP-EDT, CP-PUR or UP-PUR. The configuration can be signaled in SIB1, or in NTN-specific SIB.

In some embodiments, the UE provides location information, coarse or fine, depending on security context, network configuration etc., based on priority such that fine, coarse or no location information can be provided by the UE depending on whether the user plane data to be transmitted in the UL fits to the grant provided by the network. This is assuming that the number of bits required to indicate coarse location is less than the number of bits required to indicate the fine location.

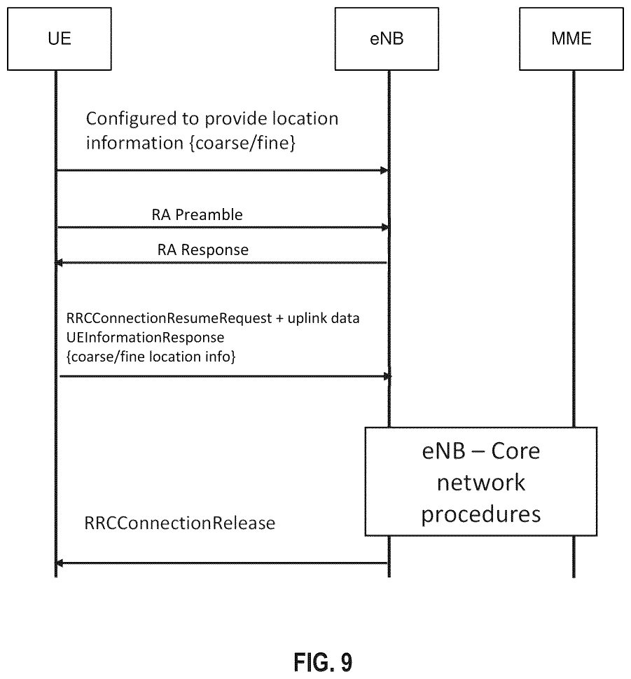

In some embodiments, the UE location is provided in a UE Information Response message that is an independent PDU that is sent in Msg3 of EDT or in the PUR PUSCH transmission. The difference between sending it in corresponding RRCConnectionResumeRequest or RRCEarlyDataRequest message is that it is an independent RRC PDU. Normally, a UE Information Response message is sent as a response to the UE Information Request, but here it can be considered that the UE information message is triggered by the UE when it has been configured by the network to do so. This can be seen in FIG. 9. In this case, there might be a need for the UE Information Response to be sent unsecured, depending on whether AS security has been established or not.

In some embodiments, if the network is not content with the location information, the UE can be given a reply message that the network requires more detailed information. This reply message can be given in a RRCConnectionReject, RRCConnectionRelease or RRCConnectionSetup message and can be of the form where the network requests a new location, or simply rejects the UE with a message which indicates that location is not accurate enough.

The action of the UE can for instance be to reply with a more detailed location as requested, or that the UE goes back in to idle in order acquire a better location, or that the UE does not attempt any more as it does not wish to give up its location info (for instance the UE might not have user consent).

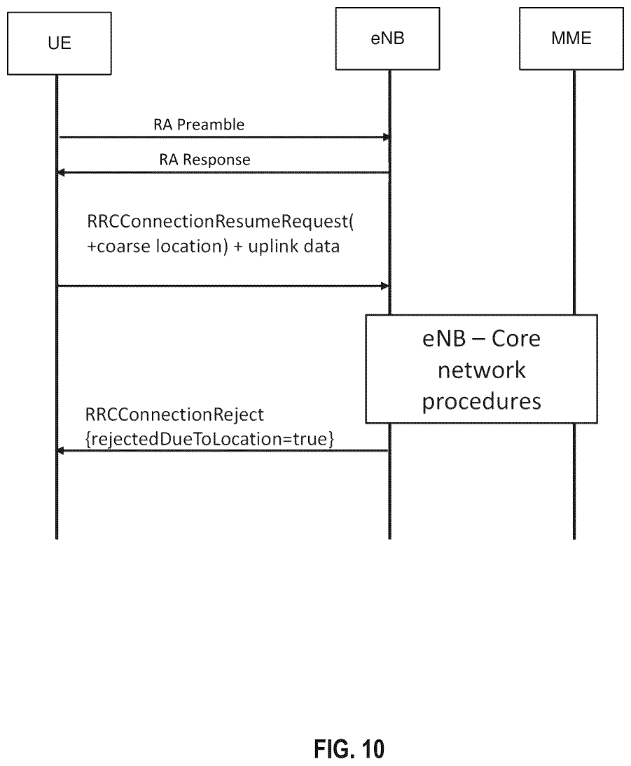

The above could for instance happen if the UE is configured to give either fine or detailed location info, but the network is not content with the location info. It could also be due to the coarse location info indicating that the UE is close to a border, thus there is a risk that the UE might be on either side of a country border and that without more detailed location info it could be difficult for the network to serve the UE given certain restrictions. For example, FIG. 10 shows an UP EDT example where coarse location is provided, but the EDT attempt is rejected due to the coarse location.

For MT-EDT, in other words the case where the EDT procedure is terminated at the UE, the procedure could be made differently. In some embodiments whether the UE sends the location information is signaled in the paging message that is sent to the UE. This can for instance be a flag telling the UE that it needs to provide either 1) coarse location, 2) fine location, 3) either fine or coarse location.

In some embodiments, UE can be configured by the network to determine the necessity of sending new location information by taking into account the state of the GNSS data and/or evaluating whether the device has experienced any significant movement. In case of absence of either coarse or fine location, the network understands that the device has not moved, and the location provided while opening the RRC context can be reused. This could be very useful in the case where the uplink has limited resources and there is a need to save bits when performing EDT and PUR, especially in satellite cases that are not moving as fast.

In some embodiments, the UE is required to deliver fine location information only if it has moved a certain distance, otherwise the UE delivers a coarse location, or no location. Similarly, for CP-EDT, the UE delivers coarse location if it has moved a certain distance otherwise no location info is sent.

In some embodiments, the location provisioning configuration is configured for Small data transmissions for an NR NTN network. This can be a part of the small data configuration, or the RRC inactive configuration. This also means that the location can be sent as part of 2-step random access rather than 4-step random access.

In some embodiments, the UE is configured to either 1) send no location, 2) send coarse location, 3) send fine location or 4) send either coarse location or fine location depending on the conditions experienced by the UE for EDT or PUR.

As variant of this, the UE can be configured with an RSRP threshold, where if the RSRP with the selected eNB/cell is below the configured threshold, the UE will include the among the options 2), 3) or 4). This can be useful as if the RSRP is good, then there might not be a need to provide a fine location, or no location at all. This can for instance depend on the beam configuration of the non-terrestrial network.

As some embodiments, the UE can be configured to provide the above options depending on if the distance to the satellite is larger than a configured threshold.

### Implementation Examples

In some embodiments, if a UE is an NTN UE and is resuming the RRC connection from a suspended RRC connection, the UE shall set the contents of RRCConnectionResumeRequest message as follows: if the UE has been configured with reportLocationEdt with value set to fineLocation, then set the ntn-LocationInfo to the fineLocationInfo, else, if the UE has been configured with reportLocationEdt with value set to coarse Location, then set the ntn-LocationInfo to the coarseLocationInfo.

In one embodiment, the syntax of the RRCConnectionResumeRequest message is as defined below:

ASN1START
RRCConnectionResumeRequest-r13 ::= SEQUENCE {
criticalExtensions CHOICE {
rrcConnectionResumeRequest-r13 RRCConnectionResumeRequest-r13-IEs,
rrcConnectionResumeRequest-r15 RRCConnectionResumeRequest-5GC-r15-IEs
}
}
RRCConnectionResumeRequest-r13-IEs ::= SEQUENCE {
resumeIdentity-r13 CHOICE {
resumeID-r13 ResumeIdentity-r13,
truncatedResumeID-r13 BIT STRING (SIZE (24))
},
shortResumeMAC-I-r13 BIT STRING (SIZE (16)),
resumeCause-r13 ResumeCause,
spare BIT STRING (SIZE (1))
}
RRCConnectionResumeRequest-5GC-r15-IEs ::= SEQUENCE {
resumeIdentity-r15 CHOICE {
fullI-RNTI-r15 I-RNTI-r15,
shortI-RNTI-r15 ShortI-RNTI-r15
},
shortResumeMAC-I-r15 BIT STRING (SIZE (16)),
resumeCause-r15 ResumeCause-r15,
spare BIT STRING (SIZE (1))
}
RRCConnectionResumeRequest-r17-IEs ::= SEQUENCE {
ntn-Location Info-r17 NTN-LocationInfo-r17
spare BIT STRING (SIZE (1))
}
ResumeCause ::= ENUMERATED {
emergency, highPriorityAccess, mt-Access, mo-Signalling,
mo-Data, delayTolerantAccess-v1020, mo-VoiceCall-v1280,
mt-EDT-v1610
}
ResumeCause-r15 ::= ENUMERATED {
emergency, highPriorityAccess, mt-Access, mo-Signalling,
mo-Data, rna-Update, mo-VoiceCall, spare1
}
-- ASN1STOP

The ntn-LocationInfo IE is used to indicate the location of the UE. The resumeCause IE provides the resume cause for the RRC connection resume request as provided by the upper layers. The network is not expected to reject a RRCConnectionResumeRequest due to unknown cause value being used by the UE. The resumeIdentity IE is used to facilitate UE context retrieval at eNB. The shortResumeMAC-I IE is an authentication token to facilitate UE authentication at eNB.

In some embodiments, the NTN-LocationInfo data type is defined as shown in the table below:

ASN1START
NTN-LocationInfo-r17 ::= CHOICE {
coarseLocationInfo-r17 CoarseLocation-r17,
fineLocationInfo-r17 LocationInfo-r10-IEs
}
ASN1STOP

The coarseLocationInfo IE is used to indicate the coarse location of the UE. The fineLocationInfo IE is used to indicate the fine location of the UE, which is used only when AS security has been established.

### SystemInformationBlockType2

The IE SystemInformationBlockType2 contains radio resource configuration information that is common for all UEs. In one embodiment, the SystemInformationBlockType2 is defined as shown in the table below:

ASN1START
SystemInformationBlockType2 ::= SEQUENCE {
ac-BarringInfo SEQUENCE {
ac-BarringForEmergency BOOLEAN,
ac-BarringForMO-Signalling AC-BarringConfig OPTIONAL, -- Need OP
ac-BarringForMO-Data AC-BarringConfig OPTIONAL -- Need OP
} OPTIONAL, -- Need OP
radioResourceConfigCommon RadioResourceConfigCommonSIB,
ue-TimersAndConstants UE-TimersAndConstants,
freqInfo SEQUENCE {
ul-CarrierFreq ARFCN-ValueEUTRA OPTIONAL, -- Need OP
ul-Bandwidth ENUMERATED {n6, n15, n25, n50, n75, n100}
OPTIONAL, -- Need OP
additionalSpectrumEmission AdditionalSpectrumEmission
},
mbsfn-SubframeConfigList MBSFN-SubframeConfigList OPTIONAL, -- Need OR
timeAlignmentTimerCommon TimeAlignmentTimer,
...,
lateNonCriticalExtension OCTET STRING (CONTAINING
SystemInformationBlockType2-v8h0-IEs) OPTIONAL,
[[ ssac-BarringForMMTEL-Voice-r9 AC-BarringConfig OPTIONAL, -- Need OP
ssac-BarringForMMTEL-Video-r9 AC-BarringConfig OPTIONAL -- Need OP
]],
[[ ac-BarringForCSFB-r10 AC-BarringConfig OPTIONAL -- Need OP
]],
[[ ac-BarringSkipForMMTELVoice-r12 ENUMERATED {true} OPTIONAL, -- Need OP
ac-BarringSkipForMMTELVideo-r12 ENUMERATED {true} OPTIONAL, -- Need OP
ac-BarringSkipForSMS-r12 ENUMERATED {true} OPTIONAL, -- Need OP
ac-BarringPerPLMN-List-r12 AC-BarringPerPLMN-List-r12 OPTIONAL -- Need OP
]],
[[ voiceServiceCauseIndication-r12 ENUMERATED {true} OPTIONAL -- Need OP
]],
[[ acdc-BarringForCommon-r13 ACDC-BarringForCommon-r13 OPTIONAL, -- Need
OP
acdc-BarringPerPLMN-List-r13 ACDC-BarringPerPLMN-List-r13 OPTIONAL -- Need
OP
]],
[[
udt-RestrictingForCommon-r13 UDT-Restricting-r13 OPTIONAL, -- Need OR
udt-RestrictingPerPLMN-List-r13 UDT-RestrictingPerPLMN-List-r13 OPTIONAL, --
Need OR
cIoT-EPS-OptimisationInfo-r13 CIOT-EPS-OptimisationInfo-r13 OPTIONAL, --
Need OP
useFullResumeID-r13 ENUMERATED {true} OPTIONAL -- Need OP
]],
[[ unicastFreqHoppingInd-r13 ENUMERATED {true} OPTIONAL -- Need OP
]],
[[ mbsfn-SubframeConfigList-v1430 MBSFN-SubframeConfigList-v1430 OPTIONAL, -
- Need OP
videoServiceCauseIndication-r14 ENUMERATED {true} OPTIONAL -- Need OP
]],
[[ plmn-InfoList-r15 PLMN-InfoList-r15 OPTIONAL -- Need OP
]],
[[ cp-EDT-r15 ENUMERATED {true} OPTIONAL, -- Need OR
up-EDT-r15 ENUMERATED {true} OPTIONAL, -- Need OR
idleModeMeasurements-r15 ENUMERATED {true} OPTIONAL, -- Need OR
reducedCP-LatencyEnabled-r15 ENUMERATED {true} OPTIONAL -- Need OR
]],
[[ mbms-ROM-ServiceIndication-r15 ENUMERATED {true} OPTIONAL -- Need OR
]],
[[ rlos-Enabled-r16 ENUMERATED {true} OPTIONAL, -- Need OR
earlySecurityReactivation-r16 ENUMERATED {true} OPTIONAL, -- Need OR
cp-EDT-5GC-r16 ENUMERATED {true} OPTIONAL, -- Need OR
up-EDT-5GC-r16 ENUMERATED {true} OPTIONAL, -- Need OR
cp-PUR-EPC-r16 ENUMERATED {true} OPTIONAL, -- Need OR
up-PUR-EPC-r16 ENUMERATED {true} OPTIONAL, -- Need OR
cp-PUR-5GC-r16 ENUMERATED {true} OPTIONAL, -- Need OR
up-PUR-5GC-r16 ENUMERATED {true} OPTIONAL, -- Need OR
mpdcch-CQI-Reporting-r16 ENUMERATED {fourBits, both} OPTIONAL, -- Need OR
rai-ActivationEnh-r16 ENUMERATED {true} OPTIONAL, -- Need OR
idleModeMeasurementsNR-r16 ENUMERATED {true} OPTIONAL -- Need OR
]],
[[ reportLocationEdt-r17 ENUMERATED {coarseLocation, fineLocation}
OPTIONAL -- Need OR
reportLocationPur-r17 ENUMERATED {coarseLocation, fineLocation }
OPTIONAL -- Need OR
]]
}

As shown in the table above, the system information may include an information element (e.g., reportLocationEdt or reportLocationPur to configure the UE's that receive the system information to report location information (e.g., fine or coarse) using EDT or PUR.

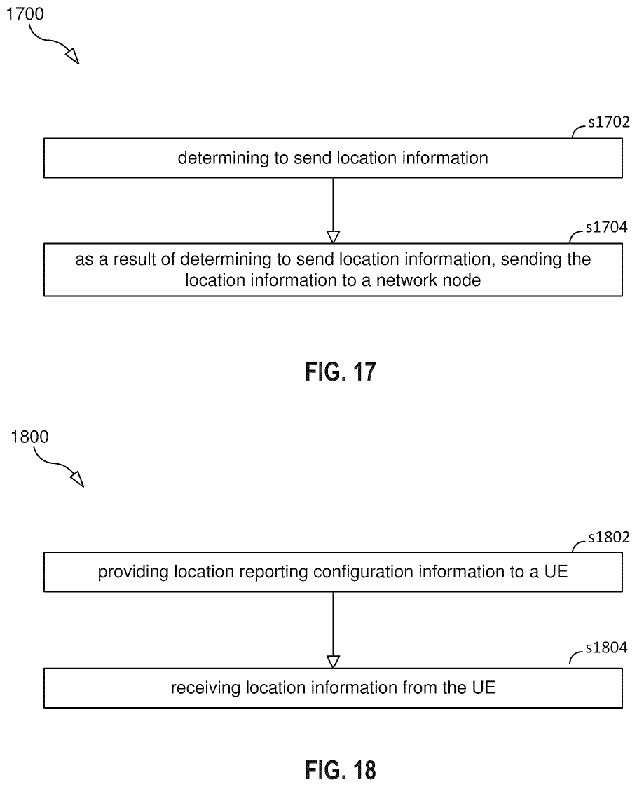

FIG. 17 is a flow chart illustrating a process 1700, according to an embodiment, that is performed by a UE. Process 1700 may begin in step s1702. Step s1702 comprises determining to send location information. Step s1704 comprises, as a result of determining to send location information, sending the location information to a network node. Sending the location information to the network node comprises: sending the location information using one or more PURs or sending a connection establishment procedure message as part of a connection establishment procedure, wherein the connection establishment procedure message comprises the location information.

FIG. 18 is a flow chart illustrating a process 1800, according to an embodiment, that is performed by a UE. Process 1800 may begin in step s1802. Step s1802 comprises providing location reporting configuration information to a UE. Step s1804 comprises receiving location information from the UE. Receiving the location information comprises receiving the location information using PURs or receiving a connection establishment procedure message as part of a connection establishment procedure, wherein the connection establishment procedure message comprises the location information.

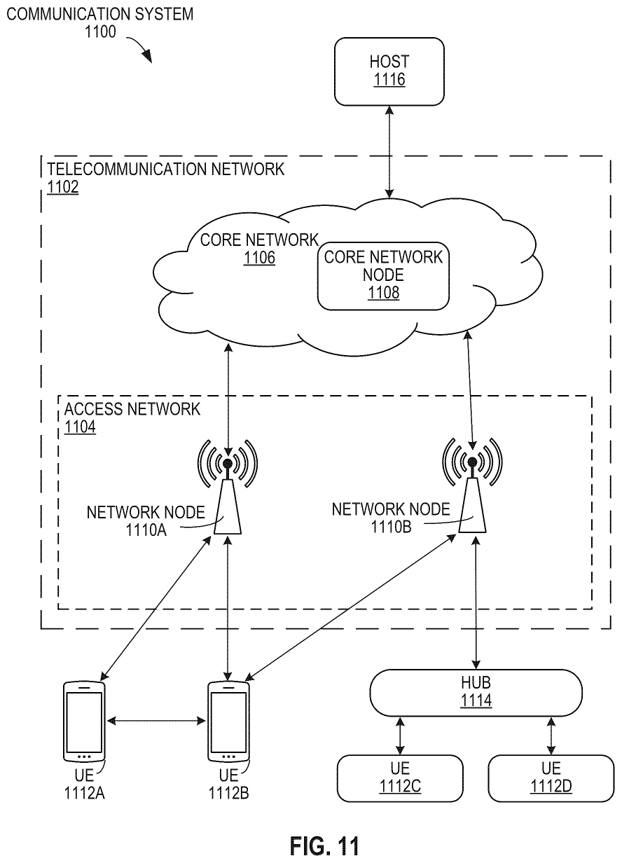

FIG. 11 shows an example of a communication system 1100 in accordance with some embodiments.

In the example, the communication system 1100 includes a telecommunication network 1102 that includes an access network 1104, such as a radio access network (RAN), and a core network 1106, which includes one or more core network nodes 1108. The access network 1104 includes one or more access network nodes, such as network nodes 1110a and 1110b (one or more of which may be generally referred to as network nodes 1110), or any other similar 3^{rd} Generation Partnership Project (3GPP) access node or non-3GPP access point. The network nodes 1110 facilitate direct or indirect connection of user equipment (UE), such as by connecting UEs 1112a, 1112b, 1112c, and 1112d (one or more of which may be generally referred to as UEs 1112) to the core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1100 may include any number of wired or wireless networks, network nodes, UEs, and/or any other components or systems that may facilitate or participate in the communication of data and/or signals whether via wired or wireless connections. The communication system 1100 may include and/or interface with any type of communication, telecommunication, data, cellular, radio network, and/or other similar type of system.

The UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with the UEs 1112 and/or with other network nodes or equipment in the telecommunication network 1102 to enable and/or provide network access, such as wireless network access, and/or to perform other functions, such as administration in the telecommunication network 1102.

In the depicted example, the core network 1106 connects the network nodes 1110 to one or more hosts, such as host 1116. These connections may be direct or indirect via one or more intermediary networks or devices. In other examples, network nodes may be directly coupled to hosts. The core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of the core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1116 may be under the ownership or control of a service provider other than an operator or provider of the access network 1104 and/or the telecommunication network 1102, and may be operated by the service provider or on behalf of the service provider. The host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1102 is a cellular network that implements 3GPP standardized features. Accordingly, the telecommunications network 1102 may support network slicing to provide different logical networks to different devices that are connected to the telecommunication network 1102. For example, the telecommunications network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1112 are configured to transmit and/or receive information without direct human interaction. For instance, a UE may be designed to transmit information to the access network 1104 on a predetermined schedule, when triggered by an internal or external event, or in response to requests from the access network 1104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1114 communicates with the access network 1104 to facilitate indirect communication between one or more UEs (e.g., UE 1112c and/or 1112d) and network nodes (e.g., network node 1110b). In some examples, the hub 1114 may be a controller, router, content source and analytics, or any of the other communication devices described herein regarding UEs. For example, the hub 1114 may be a broadband router enabling access to the core network 1106 for the UEs. As another example, the hub 1114 may be a controller that sends commands or instructions to one or more actuators in the UEs. Commands or instructions may be received from the UEs, network nodes 1110, or by executable code, script, process, or other instructions in the hub 1114. As another example, the hub 1114 may be a data collector that acts as temporary storage for UE data and, in some embodiments, may perform analysis or other processing of the data. As another example, the hub 1114 may be a content source. For example, for a UE that is a VR headset, display, loudspeaker or other media delivery device, the hub 1114 may retrieve VR assets, video, audio, or other media or data related to sensory information via a network node, which the hub 1114 then provides to the UE either directly, after performing local processing, and/or after adding additional local content. In still another example, the hub 1114 acts as a proxy server or orchestrator for the UEs, in particular in if one or more of the UEs are low energy IoT devices.

The hub 1114 may have a constant/persistent or intermittent connection to the network node 1110b. The hub 1114 may also allow for a different communication scheme and/or schedule between the hub 1114 and UEs (e.g., UE 1112c and/or 1112d), and between the hub 1114 and the core network 1106. In other examples, the hub 1114 is connected to the core network 1106 and/or one or more UEs via a wired connection. Moreover, the hub 1114 may be configured to connect to an M2M service provider over the access network 1104 and/or to another UE over a direct connection. In some scenarios, UEs may establish a wireless connection with the network nodes 1110 while still connected via the hub 1114 via a wired or wireless connection. In some embodiments, the hub 1114 may be a dedicated hub—that is, a hub whose primary function is to route communications to/from the UEs from/to the network node 1110b. In other embodiments, the hub 1114 may be a non-dedicated hub—that is, a device which is capable of operating to route communications between the UEs and network node 1110b, but which is additionally capable of operating as a communication start and/or end point for certain data channels.

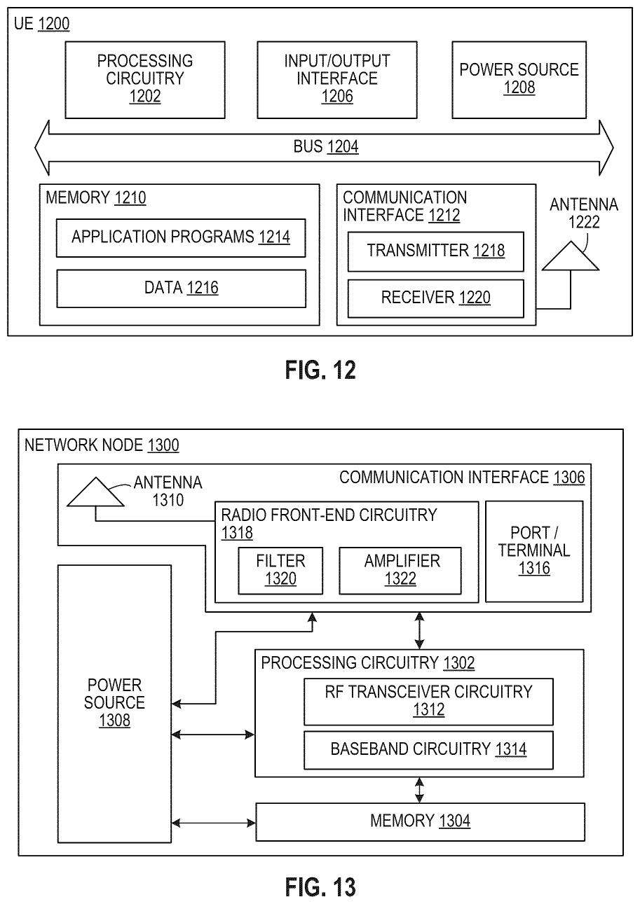

FIG. 12 shows a UE 1200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

The processing circuitry 1202 is configured to process instructions and data and may be configured to implement any sequential state machine operative to execute instructions stored as machine-readable computer programs in the memory 1210. The processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1208 is structured as a battery or battery pack. Other types of power sources, such as an external power source (e.g., an electricity outlet), photovoltaic device, or power cell, may be used. The power source 1208 may further include power circuitry for delivering power from the power source 1208 itself, and/or an external power source, to the various parts of the UE 1200 via input circuitry or an interface such as an electrical power cable. Delivering power may be, for example, for charging of the power source 1208. Power circuitry may perform any formatting, converting, or other modification to the power from the power source 1208 to make the power suitable for the respective components of the UE 1200 to which power is supplied.

The memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1210 includes one or more application programs 1214, such as an operating system, web browser application, a widget, gadget engine, or other application, and corresponding data 1216. The memory 1210 may store, for use by the UE 1200, any of a variety of various operating systems or combinations of operating systems.

The memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1210 may allow the UE 1200 to access instructions, application programs and the like, stored on transitory or non-transitory memory media, to off-load data, or to upload data. An article of manufacture, such as one utilizing a communication system may be tangibly embodied as or in the memory 1210, which may be or comprise a device-readable storage medium.

The processing circuitry 1202 may be configured to communicate with an access network or other network using the communication interface 1212. The communication interface 1212 may comprise one or more communication subsystems and may include or be communicatively coupled to an antenna 1222. The communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of the communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1200 shown in FIG. 12.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

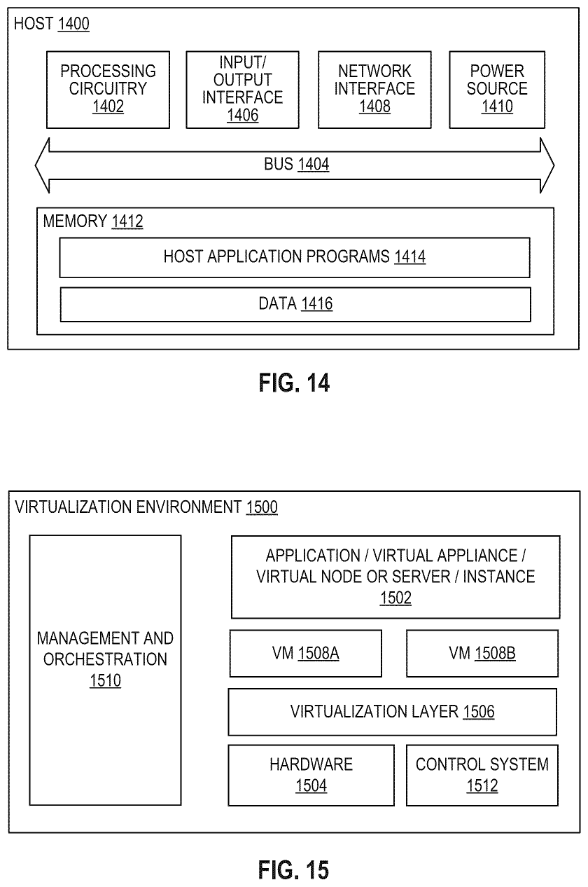

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIG. 12 and FIG. 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g. such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

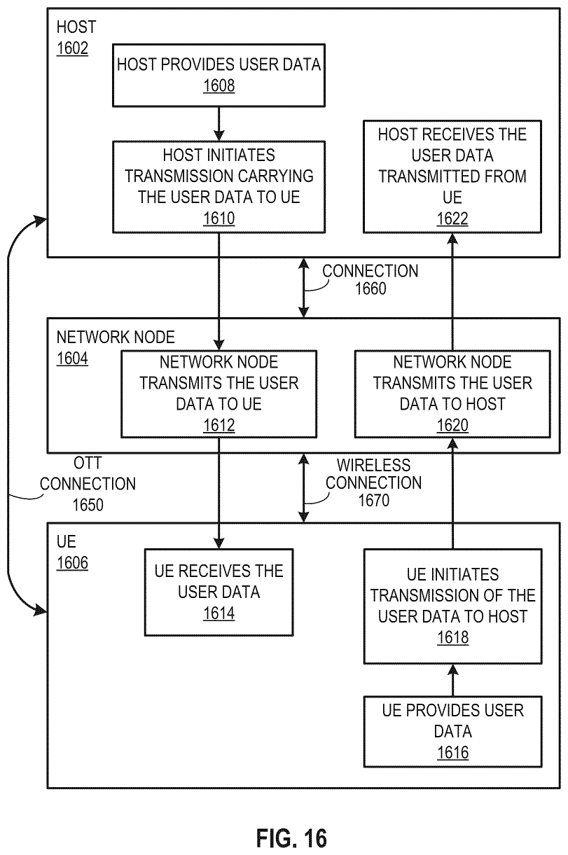

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may reduce power consumption and latency of wireless devices and thereby provide benefits such as improved battery life, reduced power consumption, faster data transfer.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Summary of Various Embodiments

### Group A Embodiments

1. A method performed by a user equipment for location provisioning, the method comprising: receiving location reporting configuration information; if applicable, sending location information to a network node.

2. The method of 1 wherein the location reporting configuration information comprises an indication of whether to send coarse location information, fine location information, or no location information.

3. The method of any of 1-2 wherein the location reporting configuration information is applicable for EDT or PUR.

4. The method of any of 1-3 further comprising determining if the user equipment needs to report its location.

5. The method of any of 1-4 wherein the location reporting configuration information is sent in Message 3.

6. The method of 4 wherein determining if the user equipment needs to report its location is based on one or more of the following factors: if a user associated with the user equipment has provided consent for location information to be provided, if the UE has accurate location information available, whether the UE is using CP-EDT or UP-EDT, CP-PUR or UP-PUR, depending on security context, depending on network configuration, whether user plane data to be transmitted in an uplink fits to the grant provided by the network, depending on if the distance to a satellite is larger than a configured threshold, depending on the relative location of the UE with respect to a cell, country, or other geographic border, depending on the state of the GNSS data, depending on the amount of movement of the UE since it last reported, depending on the conditions experienced by the UE for EDT or PUR, depending on whether an RSRP with the selected eNB/cell is above or below a configured threshold.

7. The method of any of 1-6 wherein the configuration can be signaled in SIB1, or in NTN-specific SIB.

8. The method of any of 1-7 wherein the UE location information is sent in a UE Information Response message that is an independent PDU that is sent in Msg3 of EDT or in the PUR PUSCH.

9. The method of any of 1-8 further comprising receiving a feedback message from the network node indicating that the location information needs to be resent or that more detailed location information needs to be resent.

10. The method of 9 wherein the feedback message comprises a request for a new location or a rejection of the prior location information.

11. The method of any of 1-10 further wherein the location reporting configuration information comprises signaling in the paging message that is sent to the UE.

12. The method of 11 wherein the signaling is a flag telling the UE that it needs to provide either 1) coarse location, 2) fine location, 3) either fine or coarse location.

13. The method of any of 1-12 wherein the type of location information (coarse or fine) is based on the amount of movement since the last report.

14. The method of any of the previous embodiments, further comprising: providing user data; and forwarding the user data to a host via the transmission to the network node.

### Group B Embodiments

15. A method performed by a network node for location provisioning, the method comprising: providing location reporting configuration information to a UE; receiving location information from the UE.

16. The method of 15 wherein the location reporting configuration information comprises an indication of whether to send coarse location information, fine location information, or no location information.

17. The method of any of 15-16 wherein the location reporting configuration information is applicable for EDT or PUR.

18. The method of any of 15-17 wherein the location reporting configuration information is sent in Message 3.

19. The method of 15-18 wherein the UE is continued to determine if it needs to report its location based on one or more of the following factors: if a user associated with the user equipment has provided consent for location information to be provided, if the UE has accurate location information available, whether the UE is using CP-EDT or UP-EDT, CP-PUR or UP-PUR, depending on security context, depending on network configuration, whether user plane data to be transmitted in an uplink fits to the grant provided by the network, depending on if the distance to a satellite is larger than a configured threshold, depending on the relative location of the UE with respect to a cell, country, or other geographic border, depending on the state of the GNSS data, depending on the amount of movement of the UE since it last reported, depending on the conditions experienced by the UE for EDT or PUR, depending on whether an RSRP with the selected eNB/cell is above or below a configured threshold.

20. The method of any of 15-19 wherein the configuration can be signaled in SIB1, or in NTN-specific SIB.

21. The method of any of 15-20 wherein the UE location information is received in a UE Information Response message that is an independent PDU that is received in Msg3 of EDT or in the PUR PUSCH.

22. The method of any of 15-21 further comprising sending a feedback message to the UE indicating that the location information needs to be resent or that more detailed location information needs to be sent.

23. The method of 22 wherein the feedback message comprises a request for a new location or a rejection of the prior location information.

24. The method of any of 15-23 wherein the location reporting configuration information comprises signaling in the paging message that is sent to the UE. 25. The method of 24 wherein the signaling is a flag telling the UE that it needs to provide either 1) coarse location, 2) fine location, 3) either fine or coarse location.

26. The method of any of 15-25 wherein the type of location information (coarse or fine) is based on the amount of movement since the last report.

27. The method of 25 further comprising determining that the received location information is insufficient or unsatisfactory.

28. The method of any of 15-27 further comprising determining that the UE has not moved.

29. The method of 28 further comprising reusing the location provided previously.

30. The method of any of the previous embodiments, further comprising: obtaining user data; and forwarding the user data to a host or a user equipment.

### Group C Embodiments

31. A user equipment for location provisioning, comprising: processing circuitry configured to perform any of the steps of any of the Group A embodiments; and power supply circuitry configured to supply power to the processing circuitry.

32. A network node for location provisioning, the network node comprising: processing circuitry configured to perform any of the steps of any of the Group B embodiments; power supply circuitry configured to supply power to the processing circuitry.

33. A user equipment (UE) for location provisioning, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

34. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

35. The host of the previous embodiment, wherein the cellular network further includes a network node configured to communicate with the UE to transmit the user data to the UE from the host.

36. The host of the previous 2 embodiments, wherein: the processing circuitry of the host is configured to execute a host application, thereby providing the user data; and the host application is configured to interact with a client application executing on the UE, the client application being associated with the host application.

37. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

38. The method of the previous embodiment, further comprising: at the host, executing a host application associated with a client application executing on the UE to receive the user data from the UE.

39. The method of the previous embodiment, further comprising: at the host, transmitting input data to the client application executing on the UE, the input data being provided by executing the host application, wherein the user data is provided by the client application in response to the input data from the host application.

40. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to transmit the user data to the host.

41. The host of the previous embodiment, wherein the cellular network further includes a network node configured to communicate with the UE to transmit the user data from the UE to the host.

42. The host of the previous 2 embodiments, wherein: the processing circuitry of the host is configured to execute a host application, thereby providing the user data; and the host application is configured to interact with a client application executing on the UE, the client application being associated with the host application.

43. A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

44. The method of the previous embodiment, further comprising: at the host, executing a host application associated with a client application executing on the UE to receive the user data from the UE.

45. The method of the previous embodiment, further comprising: at the host, transmitting input data to the client application executing on the UE, the input data being provided by executing the host application, wherein the user data is provided by the client application in response to the input data from the host application.

46. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

47. The host of the previous embodiment, wherein: the processing circuitry of the host is configured to execute a host application that provides the user data; and the UE comprises processing circuitry configured to execute a client application associated with the host application to receive the transmission of user data from the host.

48. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

49. The method of the previous embodiment, further comprising, at the network node, transmitting the user data provided by the host for the UE.

50. The method of any of the previous 2 embodiments, wherein the user data is provided at the host by executing a host application that interacts with a client application executing on the UE, the client application being associated with the host application.

51. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

52. The communication system of the previous embodiment, further comprising: the network node; and/or the user equipment.

53. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

54. The host of the previous 2 embodiments, wherein: the processing circuitry of the host is configured to execute a host application, thereby providing the user data; and the host application is configured to interact with a client application executing on the UE, the client application being associated with the host application.

55. The host of the any of the previous 2 embodiments, wherein the initiating receipt of the user data comprises requesting the user data.

56. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

57. The method of the previous embodiment, further comprising at the network node, transmitting the received user data to the host.

### REFERENCES

[1] 3GPP TS 36.331 “Radio Resource Control (RRC) protocol specification”, Release 16, V16.6.0, September 2021; and
[2] R2-2111110, “Discussion on UE location reporting in NTN”, RAN2 #116-e, Xiaomi, November 2021.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

| | |
|---|---|
| 3GPP | 3rd Generation Partnership Project |
| 5G | 5th Generation |
| ARQ | Automatic Repeat Request |
| BCCH | Broadcast Control Channel |
| BCH | Broadcast Channel |
| BFR | Beam Failure Recovery |
| CA | Carrier Aggregation |
| CC | Carrier Component |
| CCCH | Common Control Channel |
| CDMA | Code Division Multiplexing Access |
| CGI | Cell Global Identifier |
| CIoT | Cellular IoT |
| CP | Control Plane |
| CPICH | Common Pilot Channel |
| CQI | Channel Quality information |
| C-RNTI | Cell RNTI |
| CSI | Channel State Information |
| DCCH | Dedicated Control Channel |
| DL | Downlink |
| DMRS | Demodulation Reference Signal |
| DoNAS | Data over NAS |
| DRX | Discontinuous Reception |
| DTX | Discontinuous Transmission |
| E-CID | Enhanced Cell-ID (positioning method) |
| EDT | Early Data Transmission |
| eNB | E-UTRAN NodeB |
| ePDCCH | enhanced Physical Downlink Control Channel |
| E-UTRA | Evolved UTRA |
| E-UTRAN | Evolved UTRAN |
| FDD | Frequency Division Duplex |
| FFS | For Further Study |
| gNB | Base station in NR |
| GNSS | Global Navigation Satellite System |
| GSM | Global System for Mobile communication |
| HARQ | Hybrid Automatic Repeat Request |
| HO | Handover |
| HSPA | High Speed Packet Access |
| LOS | Line of Sight |
| LPP | LTE Positioning Protocol |
| LTE | Long-Term Evolution |
| MAC | Medium Access Control |
| MBMS | Multimedia Broadcast Multicast Services |
| MBSFN | Multimedia Broadcast multicast service Single Frequency Network |
| MIB | Master Information Block |
| MME | Mobility Management Entity |
| MSC | Mobile Switching Center |
| MPDCCH | MTC PDCCH |
| MO | Mobile-Originated |
| MT | Mobile-terminated |
| NAS | non-Access Stratum |
| NPDCCH | NB-IOT PDCCH |
| NR | New Radio |
| OCNG | OFDMA Channel Noise Generator |
| OFDM | Orthogonal Frequency Division Multiplexing |
| OFDMA | Orthogonal Frequency Division Multiple Access |
| OSS | Operations Support System |
| OTDOA | Observed Time Difference of Arrival |
| O&M | Operation and Maintenance |
| PBCH | Physical Broadcast Channel |
| P-CCPCH | Primary Common Control Physical Channel |
| PCell | Primary Cell |
| PDCCH | Physical Downlink Control Channel |
| PDCP | Packet Data Convergence Protocol |
| PDSCH | Physical Downlink Shared Channel |
| PGW | Packet Gateway |
| PLMN | Public Land Mobile Network |
| PMI | Precoder Matrix Indicator |
| PRACH | Physical Random Access Channel |
| PRS | Positioning Reference Signal |
| PSS | Primary Synchronization Signal |
| PUCCH | Physical Uplink Control Channel |
| PUR | Pre-configured Uplink Resources |
| PUSCH | Physical Uplink Shared Channel |
| RACH | Random Access Channel |
| RAN | Radio Access Network |
| RAT | Radio Access Technology |
| RLC | Radio Link Control |
| RLM | Radio Link Management |
| RNC | Radio Network Controller |
| RNTI | Radio Network Temporary Identifier |
| RO | PRACH occasion, i.e. the timing frequency resource used for on PRACH |
| | transmission |
| RRC | Radio Resource Control |
| RRM | Radio Resource Management |
| RS | Reference Signal |
| RSCP | Received Signal Code Power |
| RSRP | Reference Signal Received Power |
| RSRQ | Reference Signal Received Quality OR |
| | Reference Symbol Received Quality |
| RSSI | Received Signal Strength Indicator |
| RSTD | Reference Signal Time Difference |
| SCH | Synchronization Channel |
| SCell | Secondary Cell |
| SDAP | Service Data Adaptation Protocol |
| SDT | Small data transmission |
| SDU | Service Data Unit |
| SFN | System Frame Number |
| SGW | Serving Gateway |
| SI | System Information |
| SIB | System Information Block |
| SNR | Signal to Noise Ratio |
| SON | Self Optimized Network |
| SS | Synchronization Signal |
| SSB | Synchronization Signal Block |
| SSS | Secondary Synchronization Signal |
| SUL | Supplementary Uplink |
| TA | Timing Advance |
| TB | Transport Block |
| TDD | Time Division Duplex |
| TSS | Tertiary Synchronization Signal |
| TTI | Transmission Time Interval |
| UE | User Equipment |
| UL | Uplink |
| UMTS | Universal Mobile Telecommunication System |
| UP | User Plane |
| USIM | Universal Subscriber Identity Module |
| UTRA | Universal Terrestrial Radio Access |
| UTRAN | Universal Terrestrial Radio Access Network |
| WCDMA | Wide CDMA |
| WLAN | Wide Local Area Network |

1. A method performed by a user equipment (UE) for location provisioning, the method comprising:
determining to send location information; and
as a result of determining to send location information, sending the location information to a network node, wherein sending the location information to the network node comprises:
sending the location information using one or more preconfigured uplink resources, PURs, or
sending a connection establishment procedure message as part of a connection establishment procedure, wherein the connection establishment procedure message comprises the location information.

2. The method of claim 1, further comprising receiving location reporting configuration information, wherein the determination as to whether to send the location information or refrain from sending the location information is based on the location reporting configuration.

3. The method of claim 2, wherein the location reporting configuration information comprises an indication of whether to send coarse location information, fine location information, or no location information.

4. The method of claim 2, wherein the location reporting configuration information is applicable for an early data transmission, EDT, or a PUR transmission.

5. The method of claim 1, wherein sending the location information comprises sending the connection establishment procedure message, and the connection establishment procedure message is a message transmitted in response to receiving a random access response message transmitted by the network node.

6. The method of claim 1, further comprising determining if the user equipment needs to report its location.

7. (canceled)

8. The method of claim 2, wherein receiving the location reporting configuration information comprises receiving a broadcast system information, wherein the system information comprises the location reporting configuration information.

9. The method of claim 1, wherein the location information is sent in a UE Information Response message that is an independent PDU that is sent in Msg3 of EDT or in the PUR PUSCH.

10. (canceled)

11. The method of claim 1, further comprising receiving a feedback message from the network node indicating that the location information needs to be resent or that more detailed location information needs to be sent, wherein the feedback message comprises a request for a new location or a rejection of the prior location information.

12.-13. (canceled)

14. The method of claim 1, wherein determining whether to send location information comprises determining whether to send coarse location information or fine location information.

15. A method performed by a network node for location provisioning, the method comprising:
providing location reporting configuration information to a UE; and
receiving location information from the UE, wherein receiving the location information comprises:
receiving the location information using one or more preconfigured uplink resources, PURs, or
receiving a connection establishment procedure message as part of a connection establishment procedure, wherein the connection establishment procedure message comprises the location information.

16. The method of claim 15, wherein the location reporting configuration information comprises an indication of whether to send coarse location information, fine location information, or no location information.

17. The method of claim 15, wherein the location reporting configuration information is applicable for EDT or PUR.

18. (canceled)

19. The method of claim 18, further comprising:
receiving a random access preamble transmitted by the UE;
after receiving the random access preamble, transmitting to the UE a random access response, RAR; and
after transmitting to the UE the random access response, receiving a message responsive to the RAR, wherein the message responsive to the RAR comprises a Radio Resource Control, RRC, connection resume request message that comprises the location information.

20. (canceled)

21. The method of claim 15, wherein the location information is received in a UE Information Response message that is an independent PDU that is received in Msg3 of EDT or in the PUR PUSCH.

22. The method of any one of claims 15-21, further comprising sending a feedback message to the UE indicating that the location information needs to be resent or that more detailed location information needs to be sent wherein the feedback message comprises a request for a new location or a rejection of the prior location information.

23.-25. (canceled)

26. The method of claim 15, wherein the type of location information is based on the amount of movement since the last report.

27. The method of claim 25, further comprising determining that the received location information is insufficient or unsatisfactory.

28. The method of claim 15, further comprising determining that the UE has not moved.

29.-31. (canceled)

32. A user equipment (UE) for location provisioning, the UE comprising:
processing circuitry configured to determine to send location information; and
a communication interface configured to, as a result of determining to send location information, send the location information to a network node, wherein sending the location information to the network node comprises:
sending the location information using one or more preconfigured uplink resources, PURs, or
sending a connection establishment procedure message as part of a connection establishment procedure, wherein the connection establishment procedure message comprises the location information.

33. (canceled)

34. A network node for location provisioning, the network node comprising:
processing circuitry configured to determine location reporting configuration information to be reported to a UE; and
a communication interface configured to provide location reporting configuration information to the UE; and
receive location information from the UE, wherein receiving the location information comprises:
receiving the location information using one or more preconfigured uplink resources, PURs, or
receiving a connection establishment procedure message as part of a connection establishment procedure, wherein the connection establishment procedure message comprises the location information.

35. (canceled)
